(19) United States
(12) Patent Application Publication
(10) Pub. No.: US 2008/0277441 A1
(43) Pub. Date: Nov. 13, 2008

(54) STRAP MOUNTED ENERGY SUPPLY

(76) Inventors: Joerg Zimmermann, Vancouver (CA); Gerard F. McLean, West Vancouver (CA); Duhane Lam, Vancouver (CA); Mark Petersen, North Vancouver (CA); Jeremy Schrooten, Mission (CA)

Correspondence Address: SCHWEGMAN, LUNDBERG & WOESSNER, P.A., P.O. BOX 2938, MINNEAPOLIS, MN, 55402, US

(21) Appl. No.: 12/118,512

(22) Filed: May 9, 2008

Related U.S. Application Data
(60) Provisional application No. 60/917,512, filed on May 11, 2007.

(51) Int. Cl. A45F 4/00; A45F 5/00; A45F 3/14; H02J 15/00; B65D 85/00

(52) U.S. Cl. 224/575; 224/267; 224/257; 320/127; 206/703

(57) ABSTRACT

Embodiments of the invention relate to a strap mounted energy supply. The strap mounted energy supply includes a strap and one or more energy components. The strap is configured to couple to an electronic device, and the more energy components are conformably coupled with the strap. At least one of the one or more energy components is configured to supply energy to the electronic device. In various embodiments, the strap mounted energy supply is portable, is configured to externally couple to the electronic device, and/or is flexible, pliable, stretchable and/or ductile.

### PRIORITY OF INVENTION

This application claims priority benefit to U.S. Provisional Application No. 60/917,512, filed May 11, 2007; the entirety of which is incorporated herein by reference.

### BACKGROUND

Extending the operation of portable electronic devices currently powered by traditional batteries is becoming a sought after capability by users. In response to this, a number of battery or fuel cell powered range extending devices are being developed. A problem with these range extenders is that they exist as stand-alone power sources which connect to the devices they are powering. Such connection is either direct from a “plug and socket” connector mounted on the range extender device so that the range extender and device connect to become one physical unit, or via a connecting cable. As such, the range extenders have the negative attribute of considerably decreasing mobility of the device. For example, a mobile phone, PDA or digital camera attached to a cable which is then attached to a range extender unit, however small, considerably restricts the use of those devices.

There are optional ways of facilitating range extension into device design, or to move to fully fuel cell powered devices which offer longer range operation than can be achieved with equivalent size batteries. However, these typically require specific devices to be modified to accommodate the fuel cell components, and hence require a high degree of confidence in both user acceptance of the fuel cell technology and in the presumed availability of refueling technology. Therefore the creation of dedicated fuel cell products will likely be a longer term activity.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 illustrates a perspective view of a strap mounted energy supply, according to some embodiments.

FIG. 2 illustrates a schematic of a strap mounted energy supply, according to some embodiments.

FIG. 3 illustrates a block flow diagram of a method of supplying energy to an electronic device, according to some embodiments.

### SUMMARY

Embodiments of the invention relate to a strap mounted energy supply. The strap mounted energy supply includes a strap and one or more energy components. The strap is configured to couple to an electronic device, and the more energy components are conformably coupled with the strap. At least one of the one or more energy components is configured to supply energy to the electronic device.

Embodiments of the invention also relate to a strap mounted energy supply that includes an electronic device and a strap. The strap mounted energy supply further includes one or more energy components, one or more fuel cells, or one or more fuel cartridges in contact with the strap. The strap is in contact with and configured to couple to the electronic device. The one or more energy components, one or more fuel cells, or one or more fuel cartridges, supplies energy to the electronic device.

Embodiments of the invention also relate to an energy supplying strap that includes a strap and one or more energy components in contact with the strap. At least one of the one or more energy components supplies energy to an electronic device.

Embodiments of the invention also relate to an energy supplying strap that includes a strap, one or more fuel cells, one or more fuel cartridges, and one or more energy components. Each of the one or more fuel cells, one or more fuel cartridges, and one or more energy components are independently in contact with the strap. At least one of the one or more energy components, one or more fuel cells or one or more fuel cartridges, supplies energy to an electronic device.

Embodiments of the invention also relate to a method for supplying energy to an electronic device that includes powering an electronic device for use and transferring energy from an energy supplying strap into energy storage components within the electronic device.

Embodiments of the invention also relate to a wearable energy supply that includes a wearable article and one or more energy components. The wearable article is configured to couple to an electronic device. The one or more energy components are conformably coupled with the wearable article. At least one of the one or more energy components is configured to supply energy to the electronic device.

Embodiments of the invention also relate to a portable energy supply that includes a connector adapted to provide power to an electronic device, strap adapted to support the electronic device, and a port. The port contains a battery that would also be adapted to provide power the device, such that the battery mounted in the port can be charged when the device is powered.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense, and the scope of the present invention is defined by the appended claims and their equivalents.

In this document, the terms “a” or “an” are used to include one or more than one and the term “or” is used to refer to a nonexclusive “or” unless otherwise indicated. In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

Embodiments of the invention relate to a strap mounted energy supply. The system allows for “on-the-go” powering or recharging of an electronic device. Such electronic devices include cameras, video recorders and digital music players, for example. One or more of the energy components of the energy supply (which may be a reactant supply or power source) may be integrated into a support strap for the device, thus retaining the mobility and usefulness of the device, while also extending its operating duration without the creation of additional components for the user to carry. The energy supply may be utilized in such a way as to require little to no modification of the electronic device. The energy components of the energy supply may be integrated directly into a strap for supporting the device or integrated into a two-part strap, in which a separate overstrap is contacted with the original strap. The strap mounted energy supply may utilize battery components that are thin and flexible and which would not normally fit within the device. The strap mounted energy supply may utilize thin fuel cells and accompanying components to allow a user to utilize an electronic device for a significantly increased amount of time without replacing standard batteries or finding a charging station. The thin fuel cells may optionally be flexible. The strap mounted energy supply may provide chemical energy (such as fuel for a fuel cell) or electrical energy (i.e. electricity) or both, for example. The energy components may be small, thin and flexible to allow the strap to retain its flexibility and user comfort. As a strap is frequently utilized with electronic device use, the energy supply does not add any cumbersome components not already in use with a device and its small weight may be distributed across much of the strap.

Embodiments of the invention provide for a portable energy supply that includes a connector, strap, electronic device and a port. The connector may transfer power to the electronic device, and the port may contain a battery that would also power the device. When in use, the battery mounted in the port may be charged while the device is powered. Such a portable energy supply may specifically be a hybrid fuel cell and battery system. The fuel cell may effectively supplement the battery, such that the fuel cell extends the lifetime of the battery. In doing so, the battery may continuously power the electronic device until the battery no longer possesses a minimal charge. At such time, the fuel cell may then effectively power the electronic device. Alternatively, the fuel cell may continuously power the electronic device and the battery may provide “peak” power to the electronic device. As used herein, “peak power” refers to the power required for a peak load event such as a flash on a digital camera, lighting for a video recorder, etc. Additionally, the battery may be contained either within or outside the electronic device.

By way of illustration, a specific digital camera may require about 1 Watt of power for continuous use, but may require 10 Watts of power for operations such as a flash. As such, a portable energy supply described herein may be used to provide extended use time to the electronic device. Specifically, a portable energy supply or power source described herein may employ a fuel cell to provide about 1 Watt of power to a specific digital camera under continuous use and may employ a battery to provide power to the flash (i.e., about 10 Watts, or about 25 Watts). Such a combination may effectively extend the use time of the electronic device.

In embodiments of the invention, the energy components may be refueled or recharged. Specifically, the energy components may be refueled or recharged multiple times. The will allow for the energy components to be reused multiple times, leading to the cost effectiveness and environmental friendliness of the strap mounted energy supply described herein.

In embodiments of the invention, the strap may be configured to couple to multiple electronic devices. Each of the multiple electronic devices may be the same electronic devices, or may independently be electronic devices. Additionally, the multiple electronic devices may be used simultaneously or may be used in series, one after another.

### Definitions

As used herein, the term “energy component” refers to any component that is conformably coupled with the strap, and is configured to supply or store energy or reactants in relation to an electronic device, i.e., is related to the storage, conversion and/or transfer of energy. Examples of energy components include fuel or reactant cartridges, fluid controls, electrochemical cells, fuel reformers and power conditioning electronics that allow for chemical energy (e.g., fuel) or electrical energy (e.g., DC output) to be released or transferred from a strap mounted energy supply to an external device. The energy may be in the form of electrical energy (e.g., DC output) or chemical energy (e.g., fuel).

As used herein, the terms “external electronic device” or “electronic device” refer to a device powered by electricity from at least one or more electrochemical cells. An electronic device may include a camera, a video recorder, mobile phone, personal digital assistant (PDA), global positioning system (GPS) unit, 2-way radio, handheld point-of-sale (POS) terminal, ultramobile personal computer (PC), portable video game console, personal media player or a digital music player, for example.

As used herein, the term “flexible fuel interconnect” refers to a structure or device that allows fluidic communication between energy components. A flexible fuel interconnect may be a thin, flexible manifold, for example.

As used herein, “electrochemical cell” refers to a device that converts chemical energy to electrical energy or converts electrical energy to chemical energy. Examples of electrochemical cells may include galvanic cells, electrolytic cells, electrolyzers, fuel cells, batteries, and metal-air cells, such as zinc air fuel cells or batteries. Any suitable type of electrochemical cell including fuel cells and appropriate materials can be used according to the present invention including without limitation proton exchange membrane fuel cells (PEMFCs), solid oxide fuel cells (SOFCs), molten carbonate fuel cell (MCFCs), alkaline fuel cells, other suitable fuel cells, and materials thereof. Further examples of fuel cells include direct methanol fuel cells, alkaline fuel cells, or phosphoric acid fuel cells. Examples of batteries may include, without limitation, lithium-polymer, lithium-ion, lithium-metal, nickel metal hydride, or alkaline batteries.

An electrochemical cell layer, such as a fuel cell layer, may include one or more anodes, cathodes, and electrolyte interposed between the anodes and cathodes. In a fuel cell system, the cathodes may be supplied with air containing oxygen for use as an oxidizing agent, and the anodes may be supplied with hydrogen, for example, for use as fuel. The oxidizing agent may be supplied from air surrounding the fuel cell system, while the fuel or other reactant fluid may be supplied from the fluid reservoir.

Arrays of unit cells can be constructed to provide varied-power generating electrochemical cell layers in which the entire electrochemical structure is contained within the layer. This means additional components such as plates for collecting currents etc. can be eliminated, or replaced with structures serving different functions. Structures like those described herein are well adapted to be manufactured by continuous processes. Such structures can be designed in a way which does not require the mechanical assembly of individual parts. In some embodiments, the conductive path lengths within this structure may be kept extremely short so that ohmic losses in the catalyst layer are minimized. Array may refer to a plurality of individual unit cells. The plurality of cells may be formed on a sheet of ion exchange membrane material, a substrate, or may be formed by assembling a number of components in a particular manner.

Unit cells according to the invention may be used in a planar electrochemical cell layer that is conformable to other geometries, as described in patent application Ser. No. 11/185,755, entitled “Devices Powered by Conformable Fuel Cells”, filed on Jul. 21, 2004 and patent application Ser. No. 60/975,132, entitled “Flexible Fuel Cell”, filed on Sep. 25, 2007, which are hereby incorporated by reference.

As used herein, “electrochemical cell array” refers to one or more electrochemical cells configured to form an array that includes individual electrochemical cells that are arranged two-dimensionally in any of various suitable ways on an area covered by the array. For example, active regions of individual electrochemical cells may be arranged to provide columns of substantially parallel stripes, or shapes distributed at nodes of a two-dimensional lattice configuration, which may be a rectangular, square, triangular or hexagonal lattice, for example, and which is not necessarily completely regular. A pattern of shapes distributed in both a width and a length dimension of the area covered by the array may be provided, such that a pattern may be less regular than a lattice-type pattern, for example. Thin layer electrochemical cells, such as fuel cells, may be arranged into arrays constructed of very thin layers. Within such an array, individual unit fuel cells may be coupled in a series or series-parallel arrangement. Coupling fuel cells in such an arrangement may permit electrical power to be delivered from an array of fuel cells at increased voltages and reduced currents. This, in turn, may permit electrical conductors having smaller cross-sectional areas to be used to collect the electrical current.

Arrays can be formed to any suitable geometry. Examples of planar arrays of fuel cells are described in co-owned patent application Ser. No. 11/047,560 filed on Feb. 2, 2005 entitled “Electrochemical Cells Having Current Carrying Structures Underlying Electrochemical Reaction Layers”, the disclosure of which is herein incorporated by reference. Fuel cells in an array can also follow other planar surfaces, such as tubes as found in cylindrical fuel cells. Alternately or in addition, the array can include flexible materials that can be conformed to other geometries.

As used herein, “flexible electrochemical layer” refers to an electrochemical layer that is flexible in whole or in part, so-as-to embrace, for example, an electrochemical layer having one or more rigid components integrated with one or more flexible components. Examples of flexible layers and electrochemical layers that may adapted for use in the present invention may be found in commonly-owned McLean, et. al., U.S. patent application Ser. No. 11/327,516 entitled “Flexible Fuel Cell Structures Having External Support”, commonly-owned patent application Ser. No. 11/185,755, entitled “Devices Powered by Conformable Fuel Cells”, and commonly-owned patent application Ser. No. 60/975,132, ‘Flexible Fuel Cell’, the disclosures of which are herein incorporated in its entirety.

As used herein, “flexible 2D electrochemical cell array” refers to a flexible sheet which is thin in one dimension and which supports a number of electrochemical cells. The flexible sheet may be a composite layer, formed of one or more different materials. The fuel cells have active areas of one type (e.g. cathodes) that are accessible from one face of the sheet and active areas of another type (e.g. anodes) that are accessible from an opposed face of the sheet. The active areas may be disposed to lie within areas on their respective faces of the sheet (e.g. it is not mandatory that the entire sheet be covered with active areas, however, the performance of an electrochemical cell may be increased by increasing its active area). There are various constructions which may be used to make flexible 2D electrochemical cell arrays. Examples of flexible electrochemical cell arrays may be found in commonly owned patent application Ser. No. 61/021,581 entitled “Electrochemical Cell Assemblies Including a Region of Discontinuity”, filed Jan. 16, 2008 and patent application Ser. No. 11/047,558 entitled “Membranes and Electrochemical Cells Incorporating Such Membranes”, filed Feb. 2, 2005, and patent application Ser. No. 61/032,909, entitled “Electrochemical Cell and Membranes Related Thereto”, filed Feb. 29, 2008 the disclosures of which are herein incorporated by reference.

As used herein, “flexible” refers to a layer or component that can be deformed, bent, flexed or plied. Electrochemical cell layers, arrays, composite layers, components or coatings may be partially or substantially flexible in one or more directions.

As used herein, “fluid” refers to a continuous, amorphous substance whose molecules move freely past one another and that has the tendency to assume the shape of its container. A fluid may be a gas, liquefied gas, liquid or liquid under pressure. Examples of fluids may include fluid reactants, fuels, oxidants, and heat transfer fluids. Fluid fuels used in fuel cells may include hydrogen gas or liquid and hydrogen carriers in any suitable fluid form. Examples of fluids include air, oxygen, water, hydrogen, alcohols such as methanol and ethanol, ammonia and ammonia derivatives such as amines, hydrazine, hydrazine hydrate, aqueous hydrazine hydrate, silanes such as silane, disilane, trisilane, disilabutane, complex metal hydride compounds such as aluminum borohydride, boranes such as diborane, hydrocarbons such as cyclohexane, carbazoles such as dodecahydro-n-ethyl carbazole, and other saturated cyclic, polycyclic hydrocarbons, saturated amino boranes such as cyclotriborazane, butane, aqueous solutions of borohydride compounds such as aqueous sodium and potassium borohydrides, and formic acid.

As used herein, “fluid enclosure” may refer to a device for storing a fluid. The fluid enclosure may store a fluid physically or chemically. For example, the fluid enclosure may chemically store a fluid in active material particles. A fluid enclosure may also refer to a fluid enclosure including active material particles and an outer enclosure wall, conformably coupled to the fluid storage component and may also include structural fillers. Examples of such a fluid enclosure are found in commonly-owned patent application Ser. No. 11/473,591 entitled “Fluid Enclosure and Methods Related Thereto”, filed on Jun. 23, 2006, whose disclosure is incorporated by reference herein in its entirety.

As used herein, “flexible fluid enclosure” or “flexible portion of a fluid enclosure” may refer to a fluid enclosure including a structural filler and an outer enclosure wall, conformably coupled to the structural filler. The fluid enclosure may be flexible in one or more dimensions. Flexible may describe the expansion or contraction of the fluid enclosure in one or more dimensions. The flexibility of the fluid enclosure may exert a strain on any interface or rigid or semi-rigid components in contact with the enclosure, for example. Examples of such a fluid enclosure are found in commonly-owned U.S. patent application Ser. No. 11/473,591, referenced above.

As used herein, “composite fluid storage material” refers to active material particles mixed with a binder, wherein the binder immobilizes the active material particles sufficient to maintain relative spatial relationships between the active material particles. Examples of composite fluid storage materials are found in commonly-owned patent application Ser. No. 11/379,970, entitled “Composite Hydrogen Storage Material and Methods Related Thereto’, filed on Apr. 24, 2006, whose disclosure is incorporated by reference herein in its entirety. An example of a composite fluid storage material is a composite hydrogen storage material.

As used herein, “active material particles” refer to material particles capable of storing hydrogen or other fluids or to material particles that may occlude and desorb hydrogen or another fluid. Active material particles may include fluid-storing materials that occlude fluid, such as hydrogen, by chemisorption, physisorption or a combination thereof. Some hydrogen-storing materials desorb hydrogen in response to stimuli, such as change in temperature, change in heat or a change in pressure. Examples of hydrogen-storing materials that release hydrogen in response to stimuli, include metal hydrides, chemical hydrides, suitable micro-ceramics, nano-ceramics, boron nitride nanotubes, metal organic frameworks, palladium-containing materials, zeolites, silicas, aluminas, graphite, and carbon-based reversible fluid-storing materials such as suitable carbon nanotubes, carbon fibers, carbon aerogels, and activated carbon, nano-structured carbons or any combination thereof. The particles may also include a metal, a metal alloy, a metal compound capable of forming a metal hydride when in contact with hydrogen, alloys thereof or combinations thereof. The active material particles may include magnesium, lithium, aluminum, calcium, boron, carbon, silicon, transition metals, lanthanides, intermetallic compounds, solid solutions thereof, alloys thereof, or combinations thereof.

As used herein, “metal hydrides” may include a metal, metal alloy or metal compound capable of forming a metal hydride when in contact with hydrogen. Metal hydride compounds can be generally represented as follows: AB, AB₂, A₂B, AB₅ and BCC, respectively. When bound with hydrogen, these compounds form metal hydride complexes.

As used herein, “chemical hydride” refers to a substance that decomposes to release hydrogen including simple or complex metal hydride compounds that decompose to produce hydrogen. Simple metal hydrides that decompose to provide hydrogen include sodium hydride, lithium hydride, calcium hydride, aluminum hydride, and magnesium hydride. Complex metal hydrides that decompose to provide hydrogen include borohydrides, such as magnesium aluminum hydride, sodium borohydride, and lithium aluminum hydride. Some chemical hydrides, such as lithium aluminum hydride and sodium aluminum hydride, may decompose to release hydrogen via thermolysis reactions, by hydrolysis or by both reactions. Further examples of chemical hydrides include borazane, ammonium chloride, ammonium fluoride, titanium hydride, iron mangnesium hydride, silanes or combinations thereof. Catalysts utilized in a chemical hydride reaction may include ruthenium, cobalt, platinum, palladium, alloys thereof, or a combination thereof.

As used herein, “conformably coupled” refers to forming a bond that is substantially uniform between two components and are attached in such as way as to chemically or physically bind in a corresponding shape or form. A structural filler may be conformably coupled to an outer enclosure wall, for example, in which the outer enclosure wall chemically or physically binds to the structural filler and takes its shape.

As used herein, “outer enclosure wall” refers to the outermost layer within a fluid enclosure that serves to at least partially slow the diffusion of a fluid from the fluid enclosure. The outer enclosure wall may include multiple layers of the same or differing materials. The outer enclosure wall may include a polymer or a metal, for example.

As used herein, “structural filler” refers to a material with a sufficient tensile strength to withstand the internal pressure of a fluid enclosure, when pressurized with a fluid. Structural fillers may be solid. Structural fillers may include metallic, ceramic or plastic lattices.

As used herein, “fluid storage material” refers to a material that may be in physical or chemical contact with a fluid, usually for the purpose of assisting the storage of the fluid. Hydrogen may be chemically bound with a metal alloy to provide a metal hydride, an example of a fluid storage material.

As used herein, “occlude” or “occluding” or “occlusion” refers to absorbing or adsorbing and retaining a substance, such as a fluid. Hydrogen may be a fluid occluded, for example. The fluid may be occluded chemically or physically, such as by chemisorption or physisorption, for example.

As used herein, “desorb” or “desorbing” or “desorption” refers to the removal of an absorbed or adsorbed substance. Hydrogen may be removed from active material particles, for example. The hydrogen or other fluid may be bound physically or chemically, for example.

As used herein, “contacting” refers to physically, chemically, electrically touching or within sufficiently close proximity. A fluid may contact an enclosure, in which the fluid is physically forced inside the enclosure, for example.

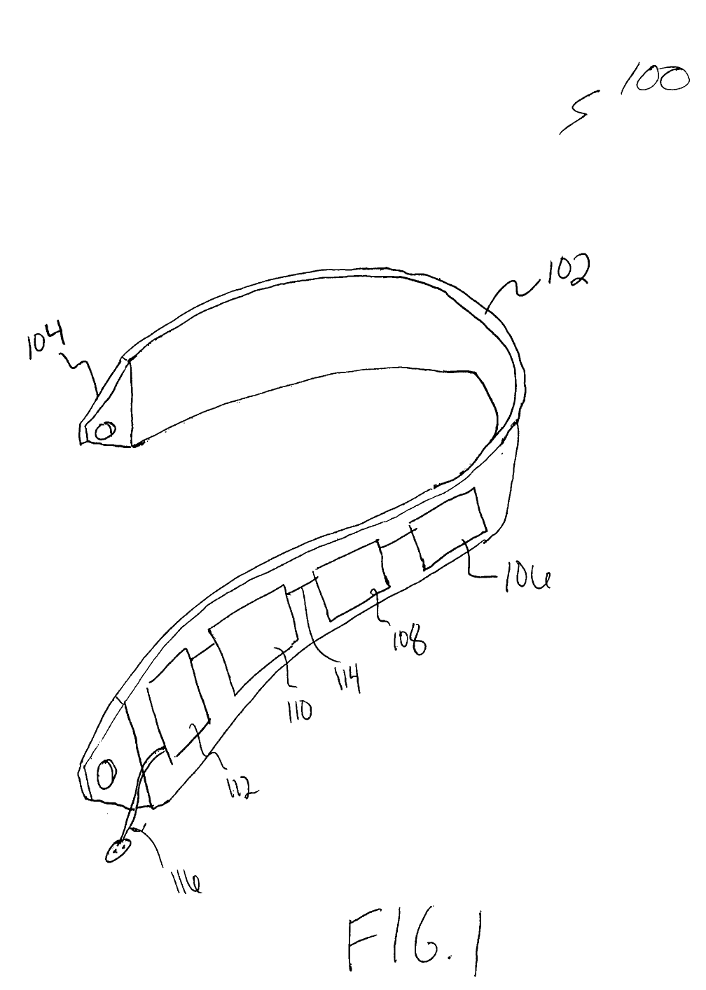

Referring to FIG. 1, a perspective view of a strap mounted energy supply or power source 100 is shown, according to some embodiments. A strap 102 may be in contact with one or more energy components. The energy components may include fuel or reactant cartridges 106, fluid controls 108, electrochemical cells 110 and power conditioning electronics 112. A flexible fuel interconnect 114 may allow the components to be in fluidic communication. An electrical connector 116 may contact an external electronic device. The strap 102 may also include attachments 104 for physically connecting to an external electronic device. The energy components may be permanently integrated into a strap 102 or be removable or replaceable, for example. The energy components may be designed as modular components that can attach to a mounted base or holder on the strap 102 and be removable or interchangeable to a certain extent. The holder may be a pouch, pocket, plastic or metal frame or base, for example.

The strap 102 may be any physical support in contact with an electronic device that may be used for carrying, grasping or holding the electronic device. For example, the strap 102 may be a shoulder strap, wrist strap, neck strap, sling or belt. The strap 102 may be about 1 cm to about 15 cm, about 1 cm to about 10 cm or about 1 cm to about 5 cm in width, for example. The strap 102 may be about 40 cm to about 100 cm, about 50 cm to about 90 cm or about 50 cm to about 80 cm in length. The strap 102 may be an OEM (original equipment manufacturer) part or sold by an after-market vendor. The strap 102 may be manufactured of a multitude of materials, but examples include web-based polymers, leather or cloth. The width of the strap 102 may vary based on size of device, type of device, style, comfort, etc. The strap 102 may have a width less than about 1 cm, less than about 5 cm or less than about 10 cm. The energy components may be integrated into the strap 102 by sewing, adhering or clipping into an attached base. The strap 102 may support all the energy supply components, or as little as the one or more fuel cartridges 106, for example. If only supporting the fuel cartridges 106, then the remainder of the system components may be in contact with or integrated into the electronic device, such as in an existing battery compartment.

Instead of strap 102, the energy supply may be integrated other types of wearable garments or articles. The garments may include a jacket, shirt, utility vest, protective vest, pants or any wearable garment that could be in contact or in close proximity to an electronic device. The energy supply may be integrated into carrying cases or bags for storing an electronic device.

The strap 102 may also be a two-part strap, in which an overstrap, such as an attachment, sleeve or cover, is in contact with an unmodified or slightly modified strap. The one or more energy components may be in contact with the overstrap. The overstrap may then be contacted with the original strap (OEM part or after-market vendor strap, for example) creating a strap mounted energy supply that can be attached to an unmodified or slightly modified original strap by the user. The two-part strap may create further uses for a strap mounted energy supply in that it can be easily applied to backpacks, shoulder bags or other accessories to electronic devices easily by a user, for example.

The fuel cartridges 106 may be fuel reservoirs that include a fuel or reactants for use in an electrochemical cell. The fuel may be hydrogen, for example. Examples of other fuels may be methanol, formic acid, butane, ethanol, chemical hydrides, hydrogen clathrate and methanol clathrate. Metal-electrolyte hydrogen generators may be utilized as well. An example of a chemical hydride may be a borohydride, such as sodium borohydride or potassium borohydride. Some fuels, for instance methanol, butane and borohydrides, may be fed directly into the electrochemical cells 110 or passed through a reformer to generate hydrogen. The fuel may be of any type that is compatible with the fluidic management system and the electrochemical cell. The fuel cartridge 106 may be a flexible fluid enclosure. A flexible fluid enclosure may include a structural filler and an outer enclosure wall, conformably coupled to the structural filler.

Fuel cartridges 106 may be utilized for storage of a fuel or reactants or act as a reaction site to generate a fuel. The components may include multiple storage units or fuel cartridges that contain one or more materials. The release of such materials may be monitored and directed by electronic or physical controls, such as when combining reactants to create an energy-related product (e.g., electrical energy or chemical energy). The materials may be combined to generate hydrogen, such as by thermolysis, hydrolysis or other reaction, for example.

If hydrogen is utilized as a fuel, it may be stored in a variety of forms. For instance, it may be compressed, liquefied or may be stored via physisorption or chemisorption with a hydrogen storage material. A composite hydrogen storage material may also be utilized.

The fuel cartridges 106 may be permanently attached or integrated into the strap 102 or an overstrap. If permanently attached, the cartridges 106 may be refillable. The cartridges 106 may also be removable and may be refillable or disposable, for example. The cartridges 106 may be thin in one dimension and largely planar in the other dimensions. One cartridge 106 may be utilized, but more than one cartridge 106 may increase the stored energy of the system to increase the duration of range extension. By utilizing multiple cartridges 106 as opposed to a few larger ones, the strap 102 may substantially retain its original flexibility. The overall two-dimensional nature of the strap 102 may be substantially unaltered. The fuel cartridges 106 may be about 5 mm to about 100 mm, about 10 mm to about 75 mm or about 25 mm to about 50 mm in width or length, depending on the application. The thickness of the cartridges 106 may be about 1.5 mm to about 20 mm, about 3 mm to about 15 mm or about 8 mm to about 12 mm, for example. The cartridges 106 may have a hydrogen storage density of about 0.025 g/cc to about 0.075 g/cc, about 0.035 g/cc to about 0.065 g/cc or about 0.040 g/cc to about 0.055 g/cc. The cartridges 106 may include a volume of fuel or reactant of about 1 ml to about 200 ml, about 1 ml to about 100 ml or about 1 ml to about 35 ml, for example.

The fluid controls 108 may describe any fluid management system used to control the flow of fuel from the fuel cartridges 106 to the electrochemical cell 110. The fluid controls 108 may include one or more of valves, check valves, pressure regulators, safety pressure or thermal relief valves, on/off valves or refueling ports, for example. Examples of fluid controls are found in commonly-owned U.S. patent application Ser. No. 12/053,374 entitled “Fluidic Control System and Method of Manufacture”, filed on 21 Mar. 2008, whose disclosure is incorporated by reference herein in its entirety.

The fluid controls 108 may operate passively, may include manual controls or may be electrically actuated with a feedback signal from other system components. The fluid controls 108 may be optional, as fuel from the fuel cartridges 106 may be directly fed to the electrochemical cells 110, without passing through any fluid controls 108, for example. When only fuel cartridges 106 are mounted on the strap, the fluid controls 108 may be placed on or inside the device being powered.

The electrochemical cells 110 may be batteries or fuel cells, for example. The electrochemical cells 110 may be small, modular and very thin. The electrochemical cells 110 may optionally be flexible. The cells 110 may convert chemical energy to electrical energy to be used by an electronic device. The electrochemical cell 110 may be a lithium polymer battery, lithium ion battery, nickel metal hydride battery or any other type of battery. The electrochemical cell 110 may be a proton exchange membrane (PEM) fuel cell, direct methanol fuel cell, direct formic acid fuel cell, direct ethanol fuel cell, alkaline fuel cell or solid oxide fuel cell, for example. Reformed hydrogen fuel cells may be utilized when a fuel processor to generate, produce or extract hydrogen from a liquid or hydrocarbon fuel is included in the energy supply in direct or indirect fluid communication with the fuel cartridge and the fuel cell. The electrochemical cell 110 may be less than about 5 mm thick, less than about 3 mm thick or less than about 1 mm thick, for example. In embodiments wherein the electrochemical cells 110 are fuel cells, they may be exposed to air and may use the oxygen in the air as an oxidant. In such embodiments, the air may be actively introduced to the fuel cell or the fuel cell may passively interact with air. The electrochemical cells 110 may be arranged into an array, which may be about 3 cm to about 15 cm, about 5 cm to about 10 cm or about 5 cm to about 7 cm in length, for example.

The power conditioning electronics 112 may be utilized to convert the electrical output from the electrochemical cells 110 to be compatible with the electrical needs of an external electronic device. The power conditioning electronics 112 may be in contact with an electrical connector 116 to supply energy to a device. The electrical connector 116 may be a generic power output, such as a USB compatible output or DC input connector. The electrical connector 116 may also be customized to be compatible with a specific device or class of devices, for example. The electrical connector 116 may be customized to be compatible only with devices from a specific manufacturer, for example. The power conditioning electronics 112 may also be optional, in that energy from an electrochemical cell 110 may be passed directly to the device via an electrical connector 116. The electrical connector 116 may be integrated into the attachments 104 so that the strap 102 automatically connects the strap mounted energy supply 100 to the device when connected.

The flexible fuel interconnect 114 may allow the one or more energy components to be in fluidic communication with one another. The connector 114 may be thin and flexible, so as to not significantly restrict the flexibility or comfort of the original strap 102. Examples of interconnects are found in commonly-owned U.S. patent application Ser. No. 12/053,366 entitled “Fluid Manifold and Method Therefor”, filed on 21 Mar. 2008, whose disclosure is incorporated by reference herein in its entirety. Attachments 104 may be mechanical or physical connections that hold the electronic device to strap 102. The attachments 104 may be clips, buckles, snaps, loops, etc., for example.

The strap mounted energy supply may provide about 1 Watt to about 50 Watts of power to an electronic device. The supply may provide about 2 W to about 3 W, about 2 to about 5 W, about 1 W to about 10 W, about 10 W to about 25 W or about 10 W to about 50 W of power to the electronic device.

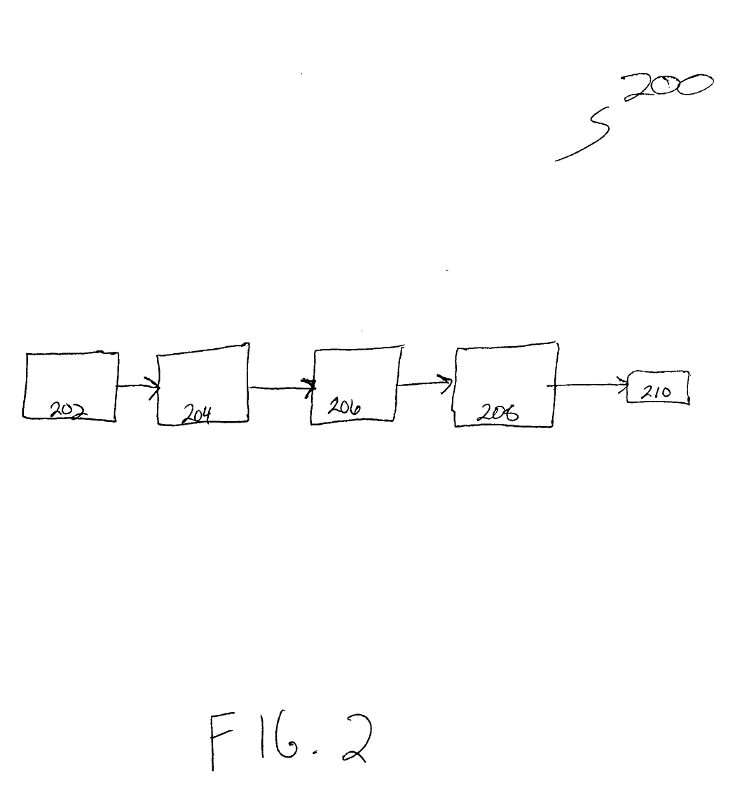

Referring to FIG. 2, a schematic of a strap mounted energy supply 200 is shown, according to some embodiments. One or more fuel cartridges 202 may be in contact with optional fluid controls 204. One or more electrochemical cells 206 may be in contact with either the fluid controls 204 or the fuel cartridges 202 and optional power conditioning electronics 208. The energy supply may then be utilized to power a load 210, such as an electronic device. Optionally, a reformer may be positioned between the one or more fuel cartridges 202 and one or more electrochemical cells 206.

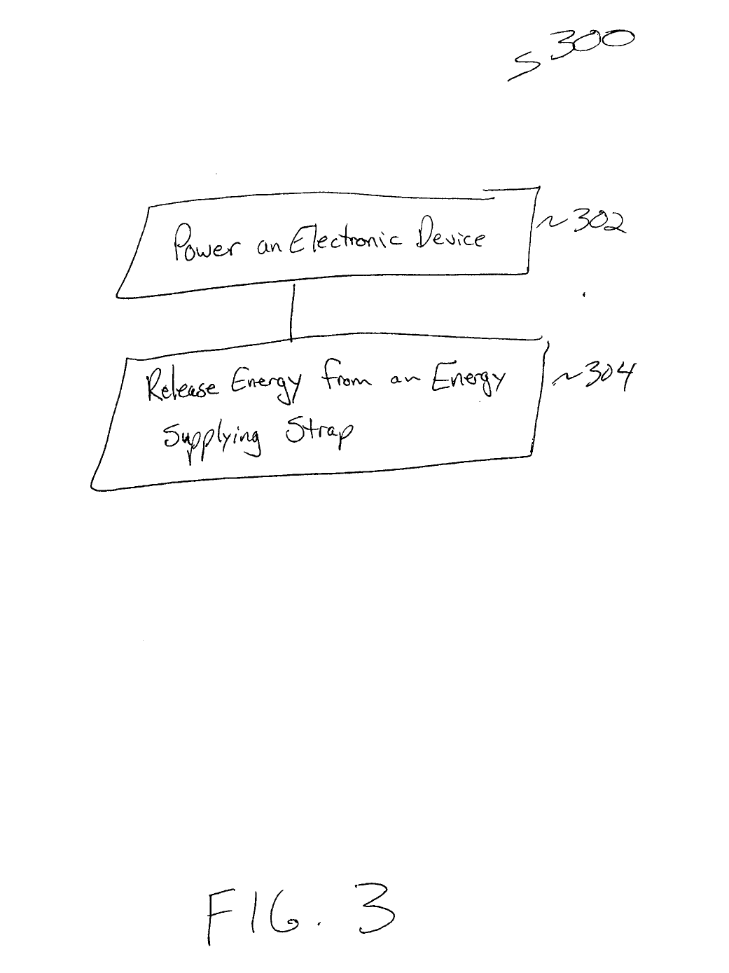

Referring to FIG. 3, a block flow diagram of a method 300 of supplying energy to an electronic device is shown, according to some embodiments. An electronic device may be powered 302. Energy may be released 304 from an energy supplying strap. Powering 302 of an electronic device may include turning on a device, using a device, or any process that utilizes electrical energy to perform. Releasing 304 energy from an energy supplying strap may include releasing or transferring chemical energy or releasing or transferring electrical energy, for example. Releasing chemical energy may include releasing a fuel from a fuel cartridge. Releasing electrical energy may include releasing or transferring the electrical output of an electrochemical cell, for example.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A strap mounted energy supply, comprising:
a strap, configured to couple to an electronic device; and
one or more energy components, conformably coupled with the strap;
wherein at least one of the one or more energy components is configured to supply energy to the electronic device.

2. The strap mounted energy supply of claim 1, which is portable.

3. The strap mounted energy supply of claim 1, which is configured to externally couple to the electronic device.

4. The strap mounted energy supply of claim 1, which is flexible, pliable, stretchable, ductile, or a combination thereof.

5. The strap mounted energy supply of claim 1, wherein the strap is configured to support the electronic device, and wherein the electronic device is portable.

6. The strap mounted energy supply of claim 1, further comprising the electronic device.

7. The strap mounted energy supply of claim 6, wherein the electronic device comprises a camera, a video recorder, mobile phone, PDA, GPS unit, 2-way radio, handheld POS terminal, ultramobile PC, portable video game console, personal media player or a digital music player.

8. The strap mounted energy supply of claim 1, wherein the strap comprises a neckstrap, wriststrap, shoulderstrap, belt, hat, vest, armstrap, jacket, shirt, or a combination thereof.

9. The strap mounted energy supply of claim 1, wherein the one or more energy components comprises one or more of electrochemical cells, fuel cartridges, fluid controls, fuel reformers, electrical connectors, flexible fuel interconnects, power conditioning electronics, and combinations thereof.

10. The strap mounted energy supply of claim 1, wherein any one of the one or more energy components comprises a fuel cell.

11. The strap mounted energy supply of claim 1, wherein any one of the one or more energy components comprises a battery.

12. The strap mounted energy supply of claim 1, wherein the energy supplied to the electronic device comprises chemical energy.

13. The strap mounted energy supply of claim 1, wherein the energy supplied to the electronic device comprises electrical energy.

14. The strap mounted energy supply of claim 1, wherein the energy supplied to the electronic device comprises fuel.

15. The strap mounted energy supply of claim 14, wherein the fuel comprises hydrogen, methanol, formic acid, butane, ethanol, chemical hydrides or a combination thereof.

16. The strap mounted energy supply of claim 9, wherein the electrochemical cell comprises a proton exchange membrane (PEM) fuel cell, direct methanol fuel cell, direct formic acid fuel cell, direct ethanol fuel cell, alkaline fuel cell or solid oxide fuel cell.

17. The strap mounted energy supply of claim 9, wherein the fuel cartridge comprises a hydrogen generator.

18. The strap mounted energy supply of claim 9, wherein the one or more energy components are permanently integrated into the strap.

19. The strap mounted energy supply of claim 9, wherein the fuel cartridges are removable.

20. The strap mounted energy supply of claim 9, wherein one or more of the one or more energy components are removable.

21. The strap mounted energy supply of claim 1, wherein one or more of the one or more energy components may be refueled or recharged one or more times.

22. The strap mounted energy supply of claim 1, wherein the strap is configured to couple to multiple electronic devices.

23. A strap mounted energy supply, comprising:
an electronic device;
a strap, in contact with and configured to couple to the electronic device; and
one or more fuel cells, in contact with the strap, one or more fuel cartridges, in contact with the strap, or one or more energy components, in contact with the strap;
wherein at least one of the one or more energy components, one or more fuel cells, or one or more fuel cartridges, supplies energy to the electronic device.

24. A method for supplying energy to an electronic device, comprising:
powering an electronic device for use; and
transferring energy from an energy supplying strap.

25. The method of claim 24, wherein the powering comprises turning on an electronic device.

26. The method of claim 24, wherein the transferring comprises transferring chemical energy.

27. The method of claim 24, wherein the transferring comprises transferring electrical energy.

28. A wearable energy supply, comprising:
a wearable article, configured to couple to an electronic device; and
one or more energy components, conformably coupled with the wearable article;
wherein at least one of the one or more energy components is configured to supply energy to the electronic device.

29. A portable energy supply comprising:
a connector adapted to provide power to an electronic device;
a strap, adapted to support the electronic device; and
a port to contain a battery that would also be adapted to provide power the device, such that the battery mounted in the port can be charged when the device is powered.

30. The portable energy supply of claim 29, wherein the battery being charged acts as a hybrid component to provide peak power into the device to which the system is connected.
